(19) United States
(12) Patent Application Publication
(10) Pub. No.: US 2007/0271318 A1
(43) Pub. Date: Nov. 22, 2007

(54) Method and Device for Processing Requests Generated by Browser Software

(75) Inventors: Vania Joloboff, Rennes (FR); Ravindra Nath Mulukutla, Singapour Inde (SG)

Correspondence Address: LOWE HAUPTMAN HAM & BERNER, LLP, 1700 DIAGONAL ROAD, SUITE 300, ALEXANDRIA, VA, 22314, US

(73) Assignee: Groupe Silicomp SA, Montbonnot Saint-Martin (FR)

(21) Appl. No.: 11/570,660

(22) PCT Filed: Jun. 13, 2005
(86) PCT No.: PCT/FR05/01449

§ 371 Date: Jan. 3, 2007

(30) Foreign Application Priority Data
Jun. 15, 2004 (FR) 0406437

(51) Int. Cl. G06F 17/30

(52) U.S. Cl. 707/205; 707/E17.005

(57) ABSTRACT

Requests generated by browser software are processed to obtain, from an information server, a principal set of information and associated secondary sets of information. A memory stores the sets of information received is associated with the browser software. A proxy receives (1) receives a request generated by the browser software for obtaining a principal set of information, (2) determines whether the principal set of information has previously been received and, (3) if so, (a) determines, for each secondary set of information, whether the secondary set of information stored by the information server differs from the secondary set of information stored in the memory associated with the browser, (b) receives a request generated by the browser software for obtaining a secondary set of information and (c) selectively transfers the request to the information server according.

### RELATED APPLICATIONS

The present application is based on, and claims priority from, France Application Number 04 06437, filed Jun. 15, 2004 and International Application No. PCT/FR05/01449, filed Jun. 13, 2005 the disclosure of which are hereby incorporated by reference herein in their entirety.

### FIELD OF THE INVENTION

The present invention concerns a method and device for processing requests generated by browser software in order to obtain, from an information server, a principal set of information and secondary set of information associated with the principal set of information.

More precisely, the present invention is situated in the field of the acceleration of the obtaining of information from a telecommunication network such as the internet network.

### BACKGROUND OF THE INVENTION

In order to accelerate the speed of obtaining information from the internet network, the prior art proposes various solutions. These are for example the use of cache memory, and the control of downloading in principle of information liable to be requested subsequently.

These techniques, used by proxy servers to which the clients accessing the internet network are connected, require having available proxy servers provided with a large memory space and therefore increasing the cost of proxy servers.

The aim of the invention is to resolve the drawbacks of the prior art by proposing a method and device for processing requests generated by at least one browser software system in order to obtain information from a network such as for example the internet network, which accelerate access to this information without its being necessary to have available proxy servers provided with a large memory space.

### SUMMARY OF THE INVENTION

To this end, according to a first aspect, the invention proposes a method of processing requests generated by browser software in order to obtain, from an information server storing sets of information, a principal set of information and secondary sets of information associated with the principal set of information. The method is performed with the aid of a memory storing the principal and secondary sets of information received by the browser software being associated with the browser software. The method comprises steps, performed by a proxy, of:

receiving a request generated by the browser software for obtaining a principal set of information,

transferring the request to the information server,

determining whether the principal set of information was previously received by the browser software and, if so

determining the secondary sets of information associated with the principal set of information,

determining, for each secondary set of information determined, whether the secondary set of information stored by the information server is different from the secondary set of information stored in the memory associated with the browser software,

receiving a request generated by the browser software for obtaining a secondary set of information associated with the principal set of information,

transferring or not the request to the information server according to the result of the difference determination step for the secondary set of information whose obtaining is requested.

Correspondingly, the invention concerns a device for processing requests generated by browser software in order to obtain, from an information server storing sets of information, a principal set of information and secondary sets of information associated with a principal set of information. A memory stores the principal and secondary information sets received by the browser software being associated with the browser software. The device comprises a processor arrangement for:

(1) receiving a request generated by the browser software for obtaining a principal set of information,

(2) transferring the request to the information server,

(3) determining whether the principal set of information was previously received by the browser software and, if so

(4) determining the secondary sets of information associated with the principal set of information,

(5) determining, for each secondary set of information determined, whether the secondary set of information stored by the information server is different from the secondary set of information stored in the memory associated with the browser software,

(6) receiving a request generated by the browser software for obtaining a secondary set of information associated with the principal set of information,

(7) transferring or not the request to the information server according to the result of the difference determination step for the secondary set of information whose obtaining is requested.

Thus it is not necessary to allocate a large amount of memory to the proxy in order to accelerate the obtaining of information. By determining which are the secondary sets of information associated with the principal set of information, and by checking whether the secondary sets of information are different from those previously obtained by the browser software, it is possible to avoid that an excessively large number of requests are transmitted to the information server.

According to another aspect of the invention, the proxy is an proxy server connected to at least one browser software system by a first telecommunication network, and the information server is connected to the proxy server by a second telecommunication network whose information transfer rate is lower than the information transfer rate of the first telecommunications network.

Thus the present invention makes it possible to manage several browser software systems and reduces the drawbacks relating to the transfer rate of the second telecommunication network.

According to another aspect of the invention, the determination of a previous reception, by the browser software, of the principal set of information and the determination of the secondary sets of information associated with the principal set of information are performed by the proxy using a table updated from previous requests made by the browser software and the table also comprises timestamping information for each secondary set of information.

Thus the various determinations are performed in a simple manner by the proxy without requiring a large memory allocation to it.

According to another aspect of the invention, the determination of a difference between the secondary set of information stored by the information server and the secondary set of information stored in the memory associated with the browser is decomposed into:

a transfer of identifiers of the secondary sets determined to the information server,

the reception for each identifier of a secondary set of information of a timestamping of the last modification of the said secondary information set,

the storage of the timestampings received,

the comparison of each timestamping received with another predetermined timestamping.

Thus the difference determination is carried out rapidly and does not require the performance of complex operations by the proxy.

According to another aspect of the invention, the request generated by the browser software for obtaining a secondary set of information is a conditional request comprising a timestamping of the last modification of the said secondary set of information known from the browser software and the other predetermined timestamping is the timestamping included in the additional request.

Knowing thus the timestamping of the last modification of the secondary set of information known from the browser software, the proxy has reliable information for determining whether the secondary set of information requested has been modified.

According to another aspect of the invention, if the request generated by the browser software for obtaining a secondary set of information associated with the principal set of information is received before the timestamping of the last modification of the said secondary set of information is received, the transfer of the request to the information server is delayed.

According to another aspect of the invention, the identifiers of the secondary sets are transferred to the information server in a single message and the information server transfers the said message to a timestamping server that determines the last modification of each secondary set included in the message.

Thus the number of requests and the quantity of information transmitted over the second telecommunication network are reduced.

The invention also concerns a computer readable medium or a storage device that stores a computer program with instructions for causing a computer system to implement the method described above.

The characteristics of the invention mentioned above, as well as others, will emerge more clearly from a reading of the following description of an example embodiment, the said description being given in relation to the accompanying drawings. BRIEF DESCRIPTION OF THE DRAWING

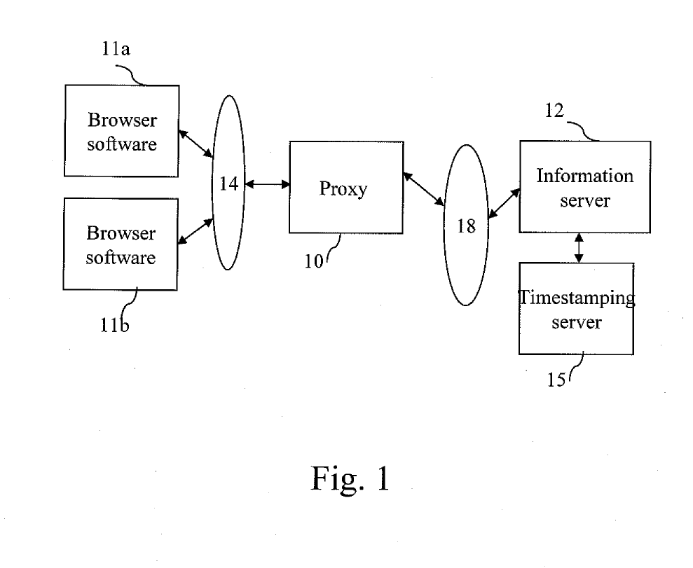

FIG. 1 depicts the architecture of the information transfer acceleration system according to the invention;

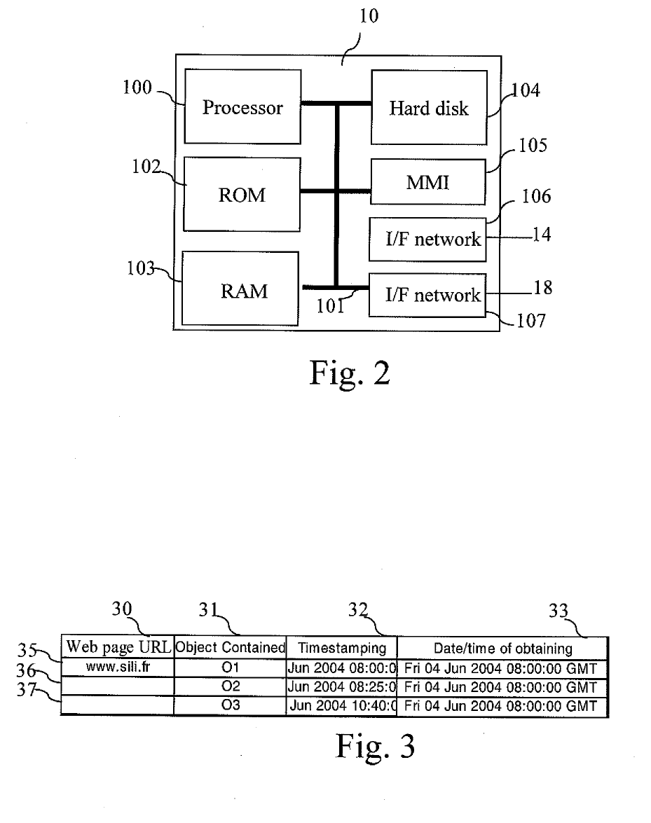

FIG. 2 depicts a schematic view of the proxy server according to the invention;

FIG. 3 depicts an example of a timestamping table used by the present invention;

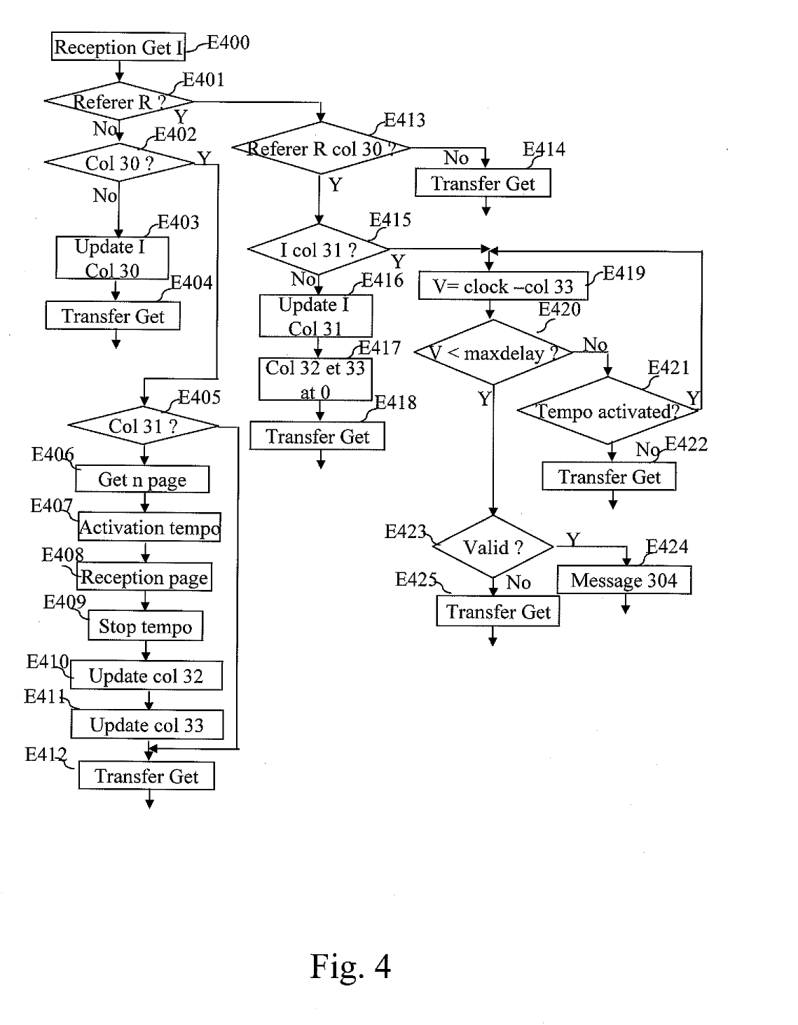

FIG. 4 depicts the algorithm executed by the proxy server according to the present invention.

### DETAILED DESCRIPTION OF THE DRAWING

FIG. 1 depicts the architecture of the information transfer acceleration system according to the invention.

The information transfer acceleration system according to the present invention comprises a proxy server 10 to which clients are connected by means of a telecommunication network 14. Each client has browser software 11. Browser software 11 makes it possible to access Web pages in accordance with the HTTP/1.1 protocol. HTTP is the acronym for HyperText Transfer Protocol. The HTTP/1.1 protocol is described in detail in the IETF recommendation RFC 2616.

Naturally other protocols can be used in the present invention.

The telecommunication network 14 is for example a telecommunication network such as a cabled or wireless local network having a high transmission rate. In FIG. 1, only two Web browser software systems 11a and 11b are depicted. These browser software systems are stored on the computers, the personal assistants or even the mobile telephones of the clients of the local network 14. Naturally a larger number of Web browsers 11 are connected to the agent server 10.

An agent server is conventionally called “proxy” server. The proxy server 10 is an intermediary between the various users of the local network 14 and another telecommunication network 18 such as the internet network. When a user connects to the internet network 18 by means of his browser software 11 or Web browser configured to use the proxy server 10, the browser software 11 connects to the proxy server 10 and transfers a request to it in order to obtain a principal set of information such as a Web page. The proxy server 10 next connects to the information server 12 that the client browser software 11 seeks to join and transmits the request to it. The information server 12 gives the Web page to the proxy server 10, which will in its turn transmit the Web page to the browser software 11.

Cache memories that store the information previously received by means of the internet network 18 are associated with the browser software 11. More precisely, the Web pages or principal sets of information, as well as the base objects, or secondary sets of information, associated with these Web pages received by browser software 11, are stored in the cache memory of the computer containing the browser software 11 that requested this information. These pages and objects are thus accessible to this browser software 11.

The information server 12 is associated with a timestamping server 15. The information server 12 is able to process static Web pages and/or dynamic Web pages. A static Web page is a page whose content is stored at a predetermined address of the information server 12. A dynamic Web page is a page whose program that permits the composition of this page is stored at a predetermined address of the information server 12.

The timestamping server 15 is able to timestamp the last modification made on the various objects associated with a Web page.

In FIG. 1, a single information server 12 is depicted for reasons of simplification. Naturally several information servers are accessible by means of the internet network 18.In a preferred embodiment, a timestamping server 15 is integrated in each information server 12 with which it is associated and therefore constitutes a module thereof. In a variant, a timestamping server is associated with each of the Web servers.

In another embodiment, a timestamping server is associated with a plurality of Web servers connected to the timestamping server by means of the internet network 18.

According to the invention, on reception of the request for obtaining a Web page, the proxy server 10 is able to check whether objects, or secondary sets of information, are associated with the Web page, or principal set of information, requested. The proxy server 10 is able to transfer to the information server 12 storing the requested Web page a request for obtaining timestamping information on the last modifications made on the various objects being associated with the Web page requested. The request for obtaining timestamping information is for example and non-limitingly a request in accordance with the HTTP/1.1 protocol for obtaining a timestamping page and is sent to the information server 12. This timestamping page comprises an identifier of the timestamping server 15 associated with the information server 12 as well as the identifiers of the various objects associated with the Web page requested.

The information server 12 is able to redirect such a request to the timestamping server 15.

The timestamping server 15 is able to execute the scripts or in other words the program associated with this page. The timestamping server 15 timestamps the last modification of each object associated with the Web page requested and, for each of these objects, returns the timestamping information to the proxy server 10 by means of the information server 12.

The proxy server 10, from this timestamping information, updates a timestamping table, for example like the one depicted in FIG. 3, and redirects or not the requests for obtaining objects associated with the requested page to the information server 12.

It should be noted here that, in another embodiment, each computer having browser software 11 has a proxy 10 able to execute the method as described in the present invention. In this variant, the telecommunication network 14 is therefore not necessary.

FIG. 2 depicts a schematic view of the proxy server according to the invention.

The proxy server 10 comprises a processor 100 connected by means of a communication bus 101 to a read-only memory ROM 102, a random access memory 103, a mass storage means such as a hard disk 104, a network interface 106 interfacing with the telecommunication network 14, a network interface 107 interfacing with the telecommunication network 18 and a man-machine interface 105.

When the proxy server 10 is brought into service, the instructions of the program corresponding to the algorithm in FIG. 4 are loaded from the read-only memory 102 into random access memory 103 and are executed by the processor 100.

The processor 100 is able to receive, by means of the network interface 106, requests to obtain Web pages, or principal sets of information, generated by Web browsers 11. The processor 100 is able to determine whether secondary sets of information are associated with these Web pages using a timestamping table for each browser software associated with it. These timestamping tables are stored on the hard disk 104. The processor 100 is able to obtain, by means of the network interface 107, timestamping information on the secondary sets of information. The processor 100 is able redirect or not, according to the timestamping information obtained, requests to obtain secondary sets of information generated by Web browsers 11.

The man-machine interface 105 consists for example of a screen, a keyboard and/or a mouse and makes it possible amongst other things to define the duration of the timings as used in the algorithm in FIG. 4.

FIG. 3 depicts an example of a timestamping table used by the present invention.

According to the invention, a timestamping table is associated with each browser software associated with the proxy server 10.

In the table as depicted in FIG. 3, a single Web page is referenced. Naturally a much larger number of Web pages are referenced in the timestamping table. These Web pages correspond to Web pages previously visited by the user of the browser software 11 associated with the proxy server 10.

The table in FIG. 3 consists of four columns denoted 30 to 33 and three rows denoted 35 to 37.

In the column 30, the URLs of the various pages previously visited by the users of the browser software associated with the proxy server 10 are listed.

In the column 31, the various secondary sets of information associated with the Web pages previously visited are listed. This information is more precisely objects such as images, audiovisual sequences or others. The column 31 is updated at step E416 of the algorithm in FIG. 4, which will be described subsequently.

The column 32 comprises the timestamping of the secondary sets of information associated with the Web pages previously visited and recorded in the column 31. The column 32 is updated at step E410 of the algorithm in FIG. 4, which will be described subsequently. The timestampings included in this column represent the dates and times of the last modifications of the secondary sets of information known from the proxy server 10.

The column 33 includes the date and time of reception of the timestamping information included in column 32. The column 33 is updated at step E411 of the algorithm in FIG. 4, which will be described subsequently.

For each Web page visited, the timestamping table comprises as many rows as there are secondary sets of information or objects associated with it. According to our example, three objects O1, O2, O3 are associated with the Web page with the address www.sili.fr.

FIG. 4 shows the algorithm executed by the proxy server according to the present invention.

The algorithm in FIG. 4 is executed at each reception of a request made by browser software 11 associated with the proxy server 10 for obtaining a Web page or objects associated with a Web page of an information server such as for example the information server 12 in FIG. 1.

At step E400, a request for obtaining a set of information I is received by the network interface 106 and retransmitted to the processor 100 of the proxy server 10. The set of information is a principal set of information or a secondary set of information associated with a principal set of information. This request is preferentially and non-limitingly a request of the “GET” type in accordance with the HTTP/1.1 protocol. This request is in a variant in accordance with the HTTP/1.0 protocol.

At step E401, the process 100 checks whether the set of information requested is a principal set of information such as a Web page or a secondary set of information such as an object associated with a Web page. For example, when the request is in accordance with the HTTP/1.1 protocol, the processor 100 checks whether, in the request for the set of information I, there is included a reference field comprising the identifier, denoted R, of the principal set of information from which the identifier of the requested set of information was obtained. This field is called the “Referer” header field in the HTTP/1.1 protocol.

If the set of information requested is a principal set of information, the processor 100 passes to step E402. At this step the processor 100 checks whether the page has previously been received by the browser software that sent the request. For example, the processor 100 checks whether the identifier of the page requested is included in column 30 of the table in FIG. 3 of the client that generated the request. If not, the processor 100 at step E403 updates the timestamping table by creating a new row, for example row 35, and inserts in column 30 the identifier of the page requested. This identifier is for example the URL www.sili.fr. Once this operation has been performed, the processor 100 at step E404 transfers the request GET onto the internet network 18 by means of the network interface 107.

If the identifier included in the request is identified in the timestamping table, and more precisely in the column 30 in FIG. 3, the processor 100 moves from step E402 to step E405. At this step, the processor 100 checks whether identifiers of secondary sets of information, or objects, associated with the principal set of information, or Web page, are known to the proxy server 10. For this, the processor 100 checks whether identifiers are included in the column 31 in FIG. 3. If not, the processor 100 moves to step E412 and transfers the request GET onto the internet network 18 by means of the network interface 107.

If identifiers are included in the column 31 in FIG. 3, the processor 100 moves from step E405 to step E406. At this step, the processor 100 reads in the timestamping table the various objects associated with the identifier of the Web page included in the request and forms a request intended for the information server 12 for obtaining a Web page. The request is for example a request of the GET type. This request comprises the identifier of the timestamping server 15 associated with the server 12 as well as the various identifiers of the various objects read in the timestamping table.

According to the example of the table in FIG. 3, the request comprises the identifiers of the object O1, O2, and O3.

When this request is received, the information server 12 transfers this request to the timestamping server 15. This request addresses a dynamic page. The timestamping server 15 executes the script associated with the Web page requested and then forms the content of this page. The script associated with this page is according to the invention a script that inserts, in the Web page, the date and time of the last modification of each object identified in the request.

At the following step E407, the processor 100 activates a counter denoted tempo.

The following step E408, the proxy server 10 receives the dynamic page comprising the date and time of the last modification of each object identified in the request.

When the dynamic page is received, the processor 100 deactivates the counter tempo at step E409.

Once this operation has been performed, the processor 100 updates the columns 32 and 33 in FIG. 3 at steps E410 and E411. For example, the processor 100 inserts, in the column 32 line 35, the date of the last modification of the object O1, that is to say O2/O6/2004 at 8:00, in the column 32, line 36 the date of the last modification of the object O2, that is to say O2/O6/2004 at 8:25, in the column 32, line 37, the date of the last modification of the object O3, that is to say O2/O6/2004 at 10:40. The processor 100 also inserts in the column 33 the date and time of reception of the dynamic page. This reception date and time is the date and time of the internal clock of the proxy server 10. It is for example O4/O6/O4 at 8:00.

Once this operation has been performed, the processor 100 transfers at step E412 the request GET onto the internet network 18 by means of the network interface 107. Once this operation has been performed, the processor 100 returns to step E400 and awaits the reception of a new request to be processed.

If, during the test of step E401 it is determined that in the request for the set of information I there is included a reference field comprising the identifier, denoted R, of the principal set of information from which the identifier of the requested set of information was obtained, the processor 100 moves to step E413.

The processor 100 checks at this step whether the Web page to which the object requested refers is or is not known to the proxy server 10. For this purpose, the processor 100 checks whether the identifier R is included in the column 30 in FIG. 3.

If the identifier is not included in the column 30, the processor 100 moves to E414 and transfers the request GET onto the internet network 18 by means of the network interface 107.

If the identifier is included in the column 30, the processor 100 moves to step E415. At this step, the processor 100 checks whether identifiers of secondary sets of information, or objects, associated with the principal set of information, or Web page, are known to the proxy server. For this purpose, the processor 100 checks whether identifiers are included in column 31 in FIG. 3. If not, the processor 100 moves to step E416 and updates the timestamping table in FIG. 3. More precisely, the processor 100 creates a new line and inserts the identifier I of the page requested. The processor 100 then at step E417 sets the fields for the timestamping and the date/time of obtaining the columns 32 and 33 to the zero value for this new line.

Once this operation has been performed, the processor 100 transfers the request GET onto the internet network 18 at step E418. Once this operation has been performed, the processor 100 returns to step E400 and awaits the reception of a new request to be processed.

If at step E415 the processor 100 determines that the identifiers of objects associated with the Web page are known to the proxy server 10, the processor 100 moves to step E419.

At this step, the processor 100 calculates, for each associated object, the variable V representing the difference between the current date and time of the proxy server 10 and respectively each date and time stored in column 33 of the table in FIG. 3.

Once this operation has been performed, the processor 100 checks at step E420 whether the variable V is below a predetermined threshold denoted “maxdelay”. This check introduces the concept of freshness of the timestamping information in column 32. This is because a date and time considered not to be fresh, that is to say when the variable V is above the predetermined threshold “maxdelay”, will not be taken into account. For example, if the predetermined threshold is 24 hours and the date and time of reception of the request received at step E400 is 6 Jun. 2004 at 10:00, the objects O1, O2 and O3 are for their part considered to be old and therefore liable to be modified. If the date and time of reception of the request received at step E400 is 4 Jun. 2004 at 18:00 the objects O1, O2 and O3 are for their part considered to be recent and therefore liable not to have modified.

If the variable V is higher than the predetermined threshold “maxdelay”, the processor 100 moves to step E421 and checks whether or not the timer activated at step E407 of the present algorithm is active. This check verifies whether a request has been made for obtaining a new object before the page requested at step E406 has been received. If so, the processor 100 returns to step E419 and reiterates steps E419 to E412 a predetermined number of times representing a delay awaiting reception of the page requested at step E406 or as long as the variable V is above the predetermined threshold maxdelay.

This check makes it possible to put on standby a request for an object when a request for obtaining timestamping information has previously been requested and not yet received. It should be noted here that, in a variant, the present algorithm does not include step E421.

If the timer activated at step E407 was deactivated at step E409, the processor 100 moves from step E421 to E422 and transfers the request GET onto the internet network 18. Once this operation has been performed, the processor 100 returns to step E400 and awaits the reception of a new request to be processed.

If the variable V is below the predetermined threshold “maxdelay”, the processor 100 moves from step E420 to step E423 and checks whether or not the object requested in the request is valid.

The check is carried out according to dates and times. These dates and times correspond to the date and time that are included in the request of the GET type received at step E400 as well as the date and time included in column 32 in FIG. 3. This is because the request received at step E400 is a conditional request. This request is for example a request of the type “If-Modified-Since” “:” HTTP-date in accordance with the HTTP/1.1 protocol.

For example, if the object requested is object O1 and the date and time included in the request GET is “Tue 01 Jun. 2004 08:00:00 GMT”, the processor 100 reads in the timestamping table in FIG. 3 the timestamping information of the object O1 of row 35 column 32. This date being equal to the date included in the request, the object requested has not been modified since the date and time included in the conditional GET request.

If the object has not been modified, the processor 100 moves to step E424 and generates a response message of the “304 not modified” type in accordance with the HTTP/1.1 protocol. The client software, on reception of such a message, consults the cache memory associated with it and thus obtains the object requested.

If the object has been modified, the processor 100 moves to step E125 and transfers the request GET onto the internet network 18. Whilst this operation is being performed, the processor 100 returns to step E400 and awaits the reception of a new request to be processed.

In a variant embodiment, instead of using timestamping information for determining whether a secondary set of information has been modified or not, other information such as a code, a digital signature or a watermark allocated to each modification of an object are used for checking whether or not a modification has been made.

According to another variant embodiment, the timestamping table in FIG. 3 does not include line 33 and the check on the freshness of the information is performed with triggerings of counters when active pages are received.

Naturally the present invention is in no way limited to the embodiments described here, but quite the contrary encompasses any variant within the capability of a person skilled in the art.

1. Method of processing requests generated by browser software in order to obtain, from an information server storing sets of information, a principal set of information and secondary sets of information associated with the principal set of information, the method being performed with the aid of a memory storing the principal and secondary sets of information received by the browser software, the method comprises steps, performed by a proxy, of:
receiving a request generated by the browser software for obtaining a set of information,
determining whether the set of information is a principal set of information or a secondary set of information, the determination being made by checking whether a field referring to a principal set of information is included in the received request,
if the set of information is a principal set of information, (a) transferring the request to the information server, (b) determining, if the set of information is a secondary set of information, whether the secondary set of information stored by the information server is different from the secondary set of information stored in the memory,
(c) transferring or preventing transfer of the request to the information server according to the results of the difference determination step for the secondary set of information whose obtaining is requested.

2. (canceled)

3. Method according to claim 1, wherein if the set of information is a principal set of information the method also comprises determining the secondary sets of information associated with the principal set of information from a table updated from previous requests made by the browser software, and updating the table with timestamping information for each set of secondary set of information.

4. Method according to claim 3, wherein the updating of the table with timestamping for each secondary set of information includes:
transfering identifiers of the secondary sets determined to the information server,
receiving, for each identifier of a secondary set of information, timestamping of the last modification of the secondary information set, and
storing the received timestamping.

5. Method according to claim 4, wherein (a) the request generated by browser software for obtaining a secondary set of information is a conditional request comprising a timestamping of the last modification of said secondary set of information and known from the browser software and, (b) the step of determining a difference between the secondary set of information stored by the information server and the secondary set of information stored in the memory associated with the browser is performed by comparing the timestamping of the secondary set of information with the timestamping included in the conditional request.

6. Method according to claim 4, wherein if the request generated by the browser software for obtaining a secondary set of information obtained with the principal set of information is received before the timestamping of the last modification of the said secondary set of information is received, the method includes awaiting the transfer of the request to the information server.

7. Method according to claim 4, further including transferring the identifiers of the secondary sets of information to the information server in a single message and causing the information server to transfers the message to a timestamping server that determines the last modification of each secondary set of information included in the message.

8. Device for processing requests generated by browser software in order to obtain, from an information server storing sets of information, a principal set of information and secondary sets of information associated with the principal set of information, a memory for storing the principal and secondary sets of information received by the browser software being associated with the browser software, the device comprising:
a receiver arrangement for receiving a request generated by the browser software for obtaining a set of information,
a processor arrangement for determining whether the set of information is a principal set of information or a secondary set of information, the processor arrangement being arranged for making the determination by checking whether a field referring to a principal set of information is included in the request received,
a transmitter arrangement for transmitting the request to the information server if the set of information is a principal set of information,
the processor arrangement being arranged for determining, if the set of information is a secondary set of information, whether the secondary set of information stored by the information server is different from the secondary set of information stored in the memory associated with the browser software,
the transmitter arrangement for selectively transmitting the request to the information server according to the results of the difference determination for the secondary set of information whose obtaining is requested.

9. A computer readable medium or a storage device including a computer program having instructions for causing a computer system to perform the method of claim 1.

10. Method according to claim 4, wherein the proxy is a proxy server linked to at least one browser software system by a first telecommunication network, the information server is connected to the proxy server by a secondary communication network having an information transfer rate lower than the information transfer rate of the first telecommunication network.

11. Device for processing requests generated by browser software in order to obtain, from an information server storing sets of information, a principal set of information and secondary sets of information associated with the principal set of information, a memory for storing the principal and secondary sets of information received by the browser software being associated with the browser software, the device comprising a processor arrangement for:
(a) receiving a request generated by the browser software for obtaining a set of information,
(b) determining whether the set of information is a principal set of information or a secondary set of information, the processor arrangement being arranged for making the determination by checking whether a field referring to a principal set of information is included in the received request,
(c) transferring the request to the information server if the set of information is a principal set of information,
(d) determining if the set of information is a secondary set of information, whether the secondary set of information stored by the information server is different from the secondary set of information stored in the memory associated with the browser software,
(e) selectively transmitting the request to the information server according to the results of the difference determination for the secondary set of information whose obtaining is requested.

12. Method according to claim 2, wherein if the set of information is a principal set of information the method also comprises determining the secondary sets of information associated with the principal set of information from a table updated from previous requests made by the browser software, and updating the table with timestamping information for each set of secondary set of information.

13. Method according to claim 5, wherein if the request generated by the browser software for obtaining a secondary set of information obtained with the principal set of information is received before the timestamping of the last modification of the said secondary set of information is received, the method includes awaiting the transfer of the request to the information server.

14. Method according to claim 5, further including transferring the identifiers of the secondary sets of information to the information server in a single message and causing the information server to transfer the message to a timestamping server that determines the last modification of each secondary set of information included in the message.

15. Method according to claim 6, further including transferring the identifiers of the secondary sets of information to the information server in a single message and causing the information server to transfer the message to a timestamping server that determines the last modification of each secondary set of information included in the message.
